(19) United States
(12) Patent Application Publication
(10) Pub. No.: US 2014/0162682 A1
(43) Pub. Date: Jun. 12, 2014

(54) OVERSHOOTING CELL DETECTION FOR SELF OPTIMIZING NETWORK APPLICATIONS

(71) Applicants: AT&T MOBILIBY II LLC, Atlanta, GA (US); AT&T INTELLECTUAL PROPERTY I, L.P., Atlanta, GA (US)

(72) Inventors: Fereidoun Tafreshi, BELLVUE, WA (US); Srikanth Hariharan, SAN RAMON, CA (US); Vibhav Kapnadak, SAN RAMON, CA (US); Hyun Ok Lee, San Ramon, CA (US); Xiaojun Tang, San Ramon, CA (US)

(73) Assignees: AT&T INTELLECTUAL PROPERTY I, L.P., Atlanta, GA (US); AT&T MOBILITY II LLC, Atlanta, GA (US)

(21) Appl. No.: 13/706,573

(22) Filed: Dec. 6, 2012

(51) Int. Cl. H04W 24/00

(52) U.S. Cl. CPC H04W 24/00
USPC 455/456.1; 455/422.1

(57) ABSTRACT

Systems and methods for overshooting cell device detection for application to self optimizing network algorithms are disclosed herein. The system ranks neighbor relationships between first, second, and third cell devices in a cellular network, based on handover statistics directly received from the cellular network. The system thereafter identifies one of the second cell device or the third cell device as an outlier neighbor cell device based on a ranking of the neighbor relationships and identifies, as a function of an azimuth direction and a distance between respective cell devices of a group of screened cell devices, an overshooting cell device that propagates a transmitted radio frequency signal causing interference to a cell device included in the group of screened cell devices.

### TECHNICAL FIELD

The disclosed subject matter relates to radio access network coverage and, more particularly, to adaptive radio access network coverage.

### BACKGROUND

By way of brief background, coverage area conditions for a radio access network (RAN) can be predicated on features of deployed radio access network equipment, including base stations, e.g., NodeB or enhanced NodeB (eNodeB). Poorly balanced cell coverage areas can be associated with poor quality user experience and increased operational costs which requires optimization efforts, and thus maintaining quality is challenging.

### BRIEF DESCRIPTION OF DRAWINGS

FIG. 1 is an illustration of an illustrative cellular network that facilitates detection of overshooting cell devices for utilization by self optimizing network applications in accordance with aspects of the subject disclosure.

FIG. 2 is a depiction of an illustrative cellular network that includes two cellular clusters for the detection of overshooting cell devices in accordance with aspects of the subject disclosure.

FIG. 3 depicts cellular cluster that includes, from the perspective of a first cell device and as a function of handover statistics, the assessed neighbor relations between first cell device and one or more disparate cell devices in accordance with aspects of the subject disclosure.

FIG. 4 is a further illustration of the cellular cluster, wherein from the perspective of a first cell device, each of the first cell device's neighbors' are employed to determine whether or not they have neighbors in accordance with aspects of the subject disclosure.

FIG. 5 provides a graphic depicting a screened cell device, a potentially overshooting cell device, and a cell device geographically situated between the screened cell device and the potentially overshooting cell device in accordance with aspects of the subject disclosure.

FIG. 6 illustrates a system that detects overshooting cell devices for utilization by self optimizing network applications in accordance with aspects of the subject disclosure.

FIG. 7 provides further illustration of a system that detects overshooting cell devices for utilization by self optimizing network applications in accordance with aspects of the subject disclosure.

FIG. 8 provides further depiction of a system that detects overshooting cell devices for utilization by self optimizing network applications in accordance with aspects of the subject disclosure.

FIG. 9 illustrates a further system that detects overshooting cell devices for utilization by self optimizing network applications in accordance with aspects of the subject disclosure.

FIG. 10 illustrates a method for detection of overshooting cell devices for utilization by self optimizing network applications in accordance with aspects of the subject disclosure.

FIG. 11 illustrates a method for facilitating overshooting cell device detection for self optimizing network applications in accordance with aspects of the subject disclosure.

FIG. 12 illustrates a further method for facilitating overshooting cell device detection for self optimizing network applications in accordance with aspects of the subject disclosure.

FIG. 13 illustrates a method for facilitating overshooting cell device detection for self optimizing network applications in accordance with aspects of the subject disclosure.

FIG. 14 is a block diagram of an example embodiment of a mobile network platform to implement and exploit various features or aspects of the subject disclosure.

FIG. 15 illustrates a block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Generally, adaptation of a radio access network coverage area, such as correcting for a base station overshoot, determining neighbor rankings for NodeB/eNodeB, etc., has not been automated. Where a radio access network is comprised of a number of cells, each associated with a base station, e.g., a NodeB/eNodeB, mobile devices can traverse the radio access network by sequentially establishing communications links with the base stations. Generally, the mobile device establishes relations with base stations that are physically closer to the mobile devices. Typically, the closer a base station is to a mobile device, the higher quality the communications link will be, all else being equivalent, because the communications signals between the base station and the mobile device have a shorter distance to traverse. As such, base stations are sometimes distributed across the radio access network in a manner that attempts to balance the area of coverage of each cell in the radio access network. Where the cells of the radio access network are closer in area of coverage, the distances between the edge of a cell and the corresponding base station can be similar to the distance between the edge of a neighboring cell and that corresponding base station. As such, when a mobile device transitions from a first cell to a second cell of similar area, the conditions for communication with each base station can be similar enough that the quality of the communications links will also be similar and the user experience can be more seamless during the transition between cells.

As mentioned, poorly balanced cell coverage areas can be associated with poor quality user experience and increased operational costs. As an example, a cell that is grossly larger than other cells in a radio access network can provide a significantly lower signal-to-noise ratio (SNR) than the other cells in the radio access network and communications links with that cell can be of lower quality. Similarly, communications with the larger cell can require higher transmit power levels, more frequent resending of lost packets, etc., and can therefore experience decreased battery life as compared with other cells of the radio access network. Additionally, where mobile devices are built to be employed in radio access network environments with evenly sized cells, an anomalous large sized cell can be associated with failed attempts to establish communications links because the communications link conditions exceed the design parameters of the mobile device which, for example, can result in high numbers of dropped calls, etc. Knowledge of the coverage areas for base stations associated with cells can be used in a radio access network to allow correction of undesirable coverage conditions, to aid in layout planning for the radio access network, etc.

While radio access network coverage conditions can be studied in a non-automated manner, such as by deploying personnel to go out into the field to measure signal-to-noise ratio values across portions of the radio access network, this raises costs and time, and can be unreliable. Further, collected measurements can be manually subjected to analysis techniques to determine information, such as a signal-to-noise ratio map of the radio access network, which can then separately be employed in adaptation of the radio access network or planning deployment of resources to improve the performance of the radio access network. Moreover, deploying individuals does not map well to modern decentralized control processes that are becoming increasingly common in radio access network operations, e.g., Long Term Evolution (LTE) cellular technologies can specify substantially more decentralized operations. As such, embodiments herein are directed to tools that can determine information that can be employed in adapting coverage area conditions in an automated manner and can be applied in decentralized control environments.

In wireless cellular networks such as universal mobile telecommunications system (UMTS), code division multiple access (CDMA), and/or Long Term Evolution (LTE), an overshooting cell device refers to a cell device whose transmitted radio frequency (RF) signal over propagates in space, resulting in a cell device serving user equipment (UE) that were not intended to be served by the cell device, or causing excessive interference to neighboring cell devices. Overshooting can be a result of improper design in network planning, but can also be beneficially exploited by network planners to reduce radio frequency coverage holes.

Self-optimization network (SON) applications are procedures that are intended to improve the radio environment through dynamic adjustments of per-cell settings, such as pilot power, elevation beam steering (tilting), azimuth direction (panning), as well as the beam width of the antenna (fanning), need to have knowledge of the overshooting cell devices and make decisions as to whether or not an overshooting cell device needs to be taken into consideration during execution of the application. In addition, proactive overshooting cell device detection can also notify other self-optimization network applications of the conditions of the cell devices and call for special attention.

The described embodiments automatically detect overshooting cell devices within a given geographic area for use by self-optimization network applications. The described embodiments can comprise data preparation, overshooting cell device classification, and action recommendation. Further, a procedure can rely on an examination of the existence of a neighbor cell device between the potentially overshooting cell device or candidate overshooting cell device and the serving cell device or serving area. The disclosed embodiments can have application for both geo-based and non geo-based self-optimization network applications.

The described procedures can be enabled as a function of cell device level data sources including performance counters, configuration management parameters and trace data, and detailed cell device information including cell tower geolocations, antenna parameters, and mobile device (e.g., user equipment) measurement reports including radio frequency and timing measurements.

Typically, self-optimization network applications that work to improve the radio environment can monitor and quantify the coverage and quality of groups of cell devices (in a cluster fashion) and then make decisions on what action or actions would best address the problem identified in the cluster. In cases where these clusters are constructed based on the cell devices that contribute to a problem, there can be a need to identify what types of cell devices are included in the cluster. Where a constructed cluster includes overshooting cell devices, there can be at risk that the self-optimization network algorithm inadvertently makes changes to an overshooting neighbor cell device and its associated cell cluster such that the change can, for example, reduce the detected coverage area of the detected overshooting cell device.

Thus far, overshooting detection has mainly been based on manual analysis of drive test data collected when trouble-shooting low performance areas, which can be costly and impractical for the optimization of large area networks.

In accordance with the foregoing, the various embodiments of this disclosure include a system comprising a memory to store computer-executable instructions and a processor coupled to the memory. The processor facilitates execution of the stored computer-executable instructions to perform operations. The operations include ranking a first neighbor relationship between a first cell device and a second cell device and a second neighbor relationship between the first cell device and a third cell device, wherein the first neighbor relationship and the second neighbor relationship are determined as a function of a handover statistic (e.g., a statistical record of a transfer of a wireless service from the first cell device to the second cell device and the statistical record of the transfer of the wireless service from the first cell device to the third cell device) received from a cellular network. Additionally, the operations include identifying the second cell device or the third cell device as an outlier neighbor cell device based on the ranking of the first neighbor relationship between the first cell device and the second cell device and the second neighbor relationship between the first cell device and the third cell device. Further, the operations include identifying, as a function of a relative azimuth direction and a relative distance between each cell device associated with a group of screened cell devices, an overshooting cell device that over propagates a transmitted radio frequency signal causing interference to a cell device included in the group of screened cell devices.

Additionally, a method is presented, the method comprising determining, by a system including a processor, from a perspective of a first cell device a relationship between the first cell device and a second cell device and between the first cell device and a third cell device, wherein the relationship between the first cell device and the second cell device and between the first cell device and the third cell device is determined from a handover statistic obtained from a cellular network. The method can also include identifying as a function of the relationship the second cell device or the third cell device as an outlier cell device and grouping the first cell device, the second cell device, and the third cell device into a list of screened cell devices. The method can further include selecting an overshooting cell device, as a function of a relative azimuth direction and a relative distance measurement between each cell device included in the list of screened cell devices, wherein the relative azimuth direction and the relative distance measurement between each cell device included in the list of screened cell devices is ascertained from a network parameter received from the cellular network.

Further, this disclosure describes a tangible computer readable medium comprising instructions. The instructions, in response to execution, cause a computing system including a processor to perform operations. The operations can include identifying an outlier cell device as a function of a median site-to-site distance between a first cell device and a second cell device and adjusting the median distance by omitting the outlier cell device from a group of screened cell devices, wherein the median site-to-site distance is established from a point of view of the first cell device and is ascertained from an analysis of a handover statistic received from a cellular network, and detecting an overshooting cell device as a function of a comparison of a relative azimuth direction and a relative distance measurement between each cell device included in the group of screened cell devices, wherein the relative azimuth direction and the relative distance measurement is determined from an analysis of a network parameter requested from the cellular network.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects and novel features of the disclosed subject matter will become apparent from the following detailed description when considered in conjunction with the provided drawings.

In an embodiment, a system can comprise a memory to store computer-executable instructions and a processor coupled to the memory. The processor facilitates execution of the stored computer-executable instructions to perform operations. The operations include ranking a first neighbor relationship between a first cell device and a second cell device and a second neighbor relationship between the first cell device and a third cell device, wherein the first neighbor relationship and the second neighbor relationship are determined as a function of a statistical record of a transfer of a wireless service from the first cell device to the second cell device and the statistical record of the transfer of the wireless service from the first cell device to the third cell device, wherein the statistical record of the transfer of the wireless service is received from a network device of a cellular network. Additionally, the operations include identifying one of the second cell device and the third cell device as an outlier neighbor cell device based on a first ranking of the first neighbor relationship and a second ranking of the second neighbor relationship. Further, the operations include identifying, as a function of an azimuth direction and a distance between respective cell devices of a group of screened cell devices, an overshooting cell device that over propagates a transmitted radio frequency signal causing interference to a cell device included in the group of screened cell devices.

The operations can also include determining a median distance of distances including a first distance between the first cell device and the second cell device and a second distance between the first cell device and the third cell device, omitting the outlier neighbor cell device from the group of screened cell devices as a function of a first comparison of the median distance with the first distance, and a second comparison of the median distance with the second distance, and classifying a candidate for the overshooting cell device associated with the group of screened cell devices based on a distance between the candidate and the first cell device exceeding a multiple of an adjusted median distance, wherein the adjusted median distance is determined after the outlier cell devices are omitted.

The operations can further include categorizing the candidate as a function of a number of neighbor relationships established by the candidate with other cell devices exceeding a configurable threshold. Additional operations can include, in response to determining that an intermediary cell device is geographically situated between the first cell device and the candidate, reclassifying the candidate as the overshooting cell device, and in response to determining that a footprint coverage area associated with the intermediary cell device satisfies a size condition, maintaining a classification for the intermediary cell device.

In another embodiment a method is disclosed. The method can comprise determining, by a system including a processor, a first relationship between the first cell device and a second cell device and a second relationship between the first cell device and a third cell device, wherein the first relationship between the first cell device and the second cell device and the second relationship between the first cell device and the third cell device is determined from a handover statistic obtained from a network device of a cellular network, and wherein the handover statistic is a statistical record of a transfer of wireless service from the first cell device to the second cell device, and from the first cell device to the third cell device. The method can also include identifying as a function of the first relationship and the second relationship one of the second cell device and the third cell device as an outlier cell device, and grouping the first cell device, the second cell device, and the third cell device in data representing a plurality of screened cell devices. The method can further include selecting, by the first cell device, an overshooting cell device, as a function of respective azimuth directions and respective distance measurements between respective cell devices included in the plurality of screened cell devices, wherein the overshooting cell device over propagates a broadcast radio frequency signal causing interference to a cell device included in the plurality of screened cell devices, wherein the respective azimuth directions and the respective distance measurements between the respective cell devices are ascertained from a network parameter received, by the system, from the cellular network.

The method can also include determining a median distance of distances including a first distance between the first cell device and the second cell device, and a second distance between the first cell device and the third cell device, comparing the median distance with the first distance and the median distance with the second distance, and determining to omit the outlier cell device from the data representing the plurality of screened cell devices based on the comparison.

Further, the method also includes identifying a potentially/candidate overshooting cell device as a function of a distance between the potentially/candidate overshooting cell device and the first cell device exceeding a multiple of an adjusted median distance, wherein the potentially/candidate overshooting cell device is included in the data representing the plurality of screened cell devices, and the adjusted median distance is determined after outlier cell devices have been omitted.

The method also includes identifying a potentially/candidate overshooting cell device based on a number of relationships established between the potentially/candidate overshooting cell device and a group of cell devices exceeding a configurable threshold, wherein the potentially/candidate overshooting cell device and the group of cell devices are included in the data representing the plurality of screened cell devices. Moreover, the method includes classifying the potentially/candidate overshooting cell device as the overshooting cell device based on a geographically intermediate cell device being determined to be present, wherein a broadcast coverage footprint associated with the geographically intermediate cell device exceeds a broadcast coverage threshold.

In a further embodiment a tangible computer readable medium comprising instructions is disclosed. The instructions, in response to execution, cause a computing system including a processor to perform operations. The operations include identifying an outlier cell device as a function of a median distance of distances including a distance between a first cell device and a second cell device and adjusting the median distance by omitting the outlier cell device from a group of screened cell devices, wherein the median distance is established from a point of view of the first cell device and determined from an analysis of transfer data representing transfer of a wireless service from the first cell device to the second cell device, and from the first cell device to the outlier cell device, wherein the transfer data is received from a network device of a cellular network, and detecting an overshooting cell device as a function of a comparison of an azimuth direction and a distance measurement between each cell device included in the group of screened cell devices, wherein the overshooting cell causes interference to a cell included in the group of screened cell devices as a result of an over propagation of a transmitted signal, wherein the azimuth direction and the distance measurement are determined from an analysis of a network parameter requested from the network device.

The operations can also include identifying a potentially/candidate overshooting cell device based on a distance between the potentially/candidate overshooting cell device and the first cell device and based on the potentially/candidate overshooting cell device being determined to be in excess of a multiple of an adjusted median distance, wherein the potentially/candidate overshooting cell device is included in the group of screened cell devices; and identifying a potentially/candidate overshooting cell device based on a number of relationships established between a group of cell devices exceeding a configurable reference point and based on a cell device being located between the first cell device and the potentially/candidate overshooting cell device.

Additional operations can include estimating a broadcast coverage area associated with a cell device situated between the first cell device and a potentially/candidate overshooting cell device, and classifying the potentially/candidate overshooting cell device as the overshooting cell device in response to the broadcast coverage area being determined to exceed a coverage area threshold. Further operations can also include eliminating the potentially/candidate overshooting cell device as a candidate for the detecting the overshooting cell device in response to the broadcast coverage area being determined not to be exceeding the coverage area threshold.

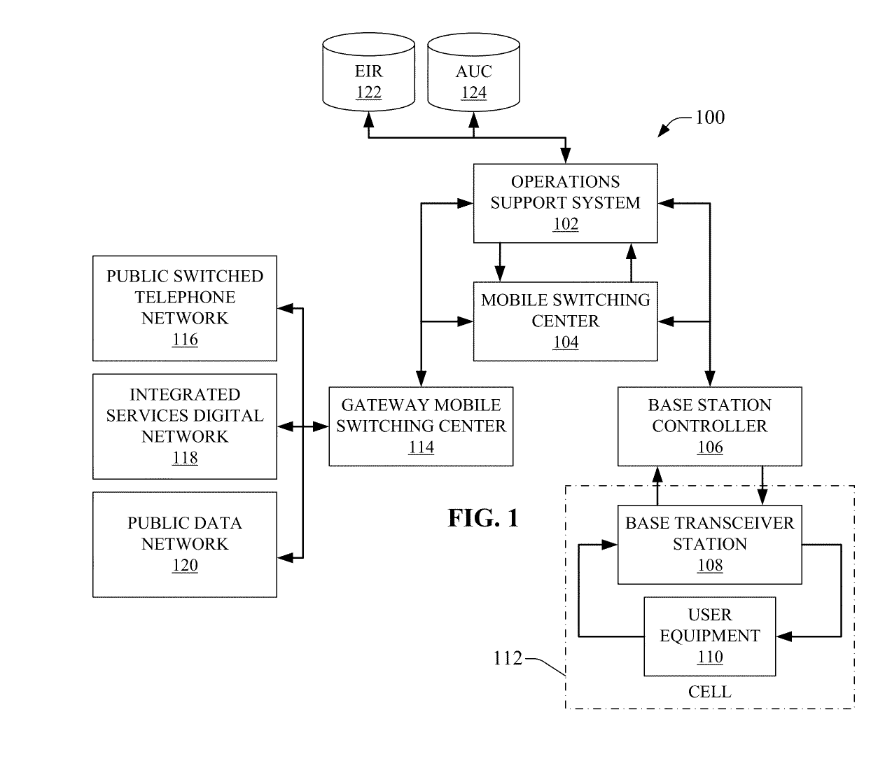

Turning now to the figures, FIG. 1 depicts an illustrative cellular network 100 that includes operations support system 102 that can be communicatively and operatively coupled to mobile switching center 104, base station controller 106, and gateway mobile switching center 114. Further, operations support system 102 can be in continuous and/or periodic communication with equipment identity register (EIR) 122 and authentication center (AUC) 124. Additionally, while not depicted, operations support system 102 can also be operatively coupled to, and/or in constant and/or sporadic communications with, other database and messaging systems typically associated with modern cellular networks, such as home location registers (HLR), visitor location registers (VLR), short message service (SMS) serving centers, chargeback centers (CBC), transcoder and adaption units (TRAU), and the like.

Generally, operations support system 102 can support processes such as maintaining network inventory, provisioning of services, configuring network components, and managing faults. In particular, and in the context of the described systems and methods, operations support system 102 can also host and support the disclosed overshooting detection process. The operations support system 102 can therefore be perceived as the functional entity from which a cellular network operator can monitor and control the cellular network; providing a network overview and supporting the maintenance activities of different operation and maintenance organizations affiliated with the cellular network operator.

As illustrated, operations support system 102 can be in communication with mobile switching center 104. Mobile switching center 104 can be responsible for routing services such as voice calls, short message service data, conference calls, circuit switched data, and the like. In this regard, mobile switching center 104 can establish and release end-to-end connections, handle mobility and hand-over requirements during calls, and oversee payment and account monitoring. As depicted mobile switching center 104 can be in intermittent or continuous communication with base station controller 106 and/or gateway mobile switching center 114.

As further depicted in FIG. 1, operations support system 102 can be in operative correspondence with base station controller 106. Base station controller 106 can be responsible for relaying and handling traffic and signaling between base transceiver station 108, operations support system 102, and/or mobile switching center 104. Base station controller 106 can provide operations and maintenance connections to operations support system 102 and can manage the operational states of one or more base transceiver stations (e.g., base transceiver station 108) for which base station controller 106 has authority and/or control. Typically, base station controller 106 can provide much of the intelligence behind each subordinate base transceiver station 108. Generally, base station controller 106 can have many tens or hundreds of base transceiver stations (e.g., base transceiver station 108) under its purview. Accordingly, base station controller 106 can be tasked to handle allocation of radio channels; receive, through base transceiver station 108, measurement reports from user equipment 110; and/or control handovers between subordinate base transceiver stations (e.g. base transceiver station 108) over which base station controller 106 exerts operational control.

Base transceiver station 108, as depicted can be in communication with base station controller 106 and/or user equipment 110. As has been noted above, base transceiver station 108 can be but one of several base transceiver stations over which base station controller 106 exerts control and/or authority. In the depicted cellular network 100, base transceiver station 108 can be utilized to facilitate wireless communication between user equipment 110 and the network (e.g. cellular network 100). Base transceiver station 108 can include equipment for transmitting and receiving radio signals (e.g., transceivers), antennas, and equipment for encrypting and decrypting communications with base station controller 106. Typically, base transceiver station 108 can have several transceivers associated with it, which allow base transceiver station 108 to serve several different frequencies and different sectors of a particular cell. As has been noted earlier, base transceiver station 108 can be controlled and monitored by base station controller 106, wherein base station controller 106 provides operations and maintenance connections to the wider network (e.g., cellular network 100) and manages operational the state of each transceiver associated with base transceiver station 108.

User equipment 110 can include, for example, cellular phones, smart phones, laptops, handheld communication devices, handheld computing devices, satellite radios, global positioning systems, personal data assistants (PDAs), and/or any other suitable device for communication over cellular network 100. As depicted, user equipment 110 can be in communication with base station transceiver 108 via groups of reception and/or transmission antennas (not shown) associated with base transceiver station 108. For example, in an embodiment, user equipment 110 can receive information transmitted by transmission antennas associated with base transceiver station 108 over a forward link, and can return information to reception antennas associated with base transceiver station 108 over a reverse link.

In a multiple access wireless communication system, such as cellular network 100, the system can include multiple cells, e.g., cell 112 represents but one cell, that can include a plurality of base transceiver stations (e.g., base transceiver station 108) under the control of a base station controller (e.g., base station controller 106). Each base transceiver station 108, under the control of a base station controller 106, situated within each respective cell, can subdivide, partition, or sectorize a cell 112 into multiple sectors, wherein the multiple sectors are formed by groups of antennas associated with a base transceiver station responsible for communication with user equipment (e.g., user equipment 110) extant within a portion of the cell. As will be appreciated, each cell can include user equipment, also known interchangeably as mobile devices, mobile stations, or access terminals, that can be in communication with one or more sectors associated with a base transceiver station responsible for a particular cell.

Gateway mobile switching center 114 can be in communication with operations support system 102 and mobile switching center 104. Gateway mobile switching center 114 can be responsible for routing services such as voice calls, short message service data, conference calls, circuit-switched data, and the like. In this regard, gateway mobile switching center 114 can have a similar functionality to that provided by mobile switching center 104. Thus, gateway mobile switching center 114 can determine at which mobile switching center (e.g., mobile switching center 104) a particular subscriber (e.g., a user of user equipment 110) who is being called is currently located at (e.g., which mobile switching center 104 should handle directing the communication). Gateway mobile switching center 114 can interface with public switched telephone network 116, integrated services digital network 118, and/or public data network 120. Generally it should be noted, all user equipment to user equipment calls and public switched telephone network to user equipment calls are typically routed through the gateway mobile switching center (e.g., gateway mobile switching center 114).

As noted above, public switched telephone network 116 can interface with cellular network 100 through gateway mobile switching center 114. Public switched telephone network 116 is the network of circuit switched telephone networks that can include telephone lines, fiber optic cables, microwave transmission links, cellular networks, communications satellites, etc., all connected by respective switching centers thereby allowing any telephone in the world to communicate with other telephones.

Integrated services digital network 118, like public switched telephone network 116, can interface with cellular network 100 through the facilities provided by gateway mobile switching center 114. Typically, integrated services digital network 118 provides access to packet switched networks thereby allowing digital transmission of voice and data over copper wire, for example. Generally, integrated services digital network 118 provides circuit switched connections for either voice or data and packet switched connections for data.

Public data network 120, like public switched telephone network 116 and integrated services digital network 118, public data network 120 can interface with cellular network 100 using services provided by gateway mobile switching center 114. Public data network 120 is typically a circuit-switched or packet-switched network available to the public that transmits data in digital form. Generally, public data networks are provided by commercial entities that provide guaranteed bandwidth to their subscribers.

As illustrated in FIG. 1, equipment identity register (ER) 122 can be a database with which operations support system 102 can continuously and/or periodically access. Equipment identity register 122 can maintain lists of user equipment that are to be monitored should they access cellular network 100. Typically, these lists of user equipment to be monitored are designed to allow tracking of stolen user equipment (e.g., stolen smart phones, mobile device, etc.) and to prevent these devices from accessing cellular network 100.

As also illustrated in FIG. 1, authentication center (AUC) 124 is a further database that can be accessed (periodically and/or continuously) by operations support system 102 so that user equipment can be authenticated to cellular network 100. Typically, authentication center 124 generates authentication triplets that can be utilized for the authorization of user equipment to access cellular network 100 using a challenge/response form of authentication process.

It should be noted in the context of the various components identified above, that communication between these components can be effectuated through wired and/or wireless modalities. For instance, communication between operations support system 102 and equipment identity register 122 can be effectuated via wired communication, whereas communication between user equipment 110 and base transceiver station 108 can be effectuated using wireless communication. Further, communication between base station controller 106 and base transceiver station 108 can be effectuated and/or facilitated using both wired and wireless communication.

Further, in connection with communication between the identified and/or depicted components, it should be appreciated that the identified and/or illustrated components can comprise or form a network topology and/or cloud that can include utilization of any viable communication and/or broadcast technology. For instance, wired and/or wireless modalities and/or technologies can be utilized to effectuate and/or facilitate the disclosed systems and methods. Moreover, the network topology and/or cloud can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof. Additionally, the network topology and/or cloud can include or encompass communications or interchange utilizing Near-Field Communications (NFC), for example.

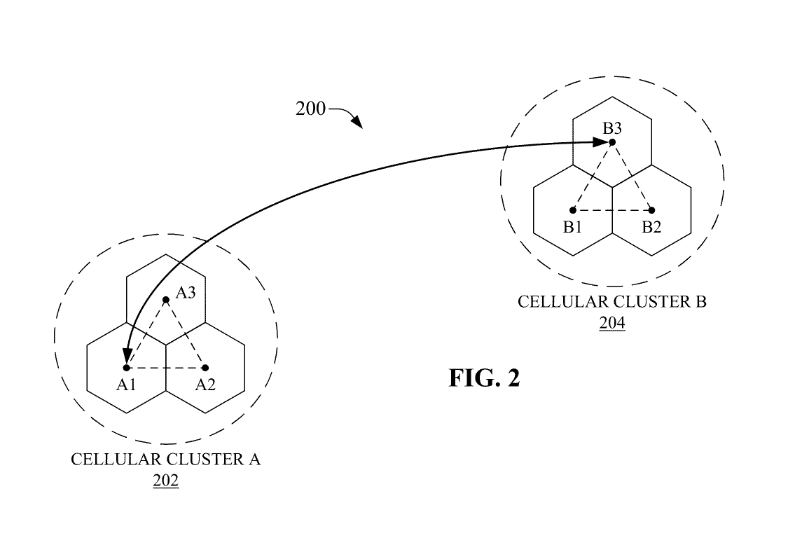

FIG. 2 provides depiction of an illustrative cellular network 200 that includes two cellular clusters, cellular cluster A 202 and cellular cluster B 204. Cellular cluster A 202 can comprise three cells (A1, A2, and A3) corresponding with one another (represented as dashed lines between each of cell A1, cell A2, and cell A3), similarly cellular cluster B 204 can also comprise three cells (B1, B2, and B3) in communication with one another (once again represented as dashed lines between each of cell B1, cell B2, and cell B3). It should be noted that the composition of cellular cluster A 202 and/or cellular cluster B 204 as comprising but three cells is only for purposes of exposition, cellular cluster A 202 and/or cellular cluster B 204 can include a greater or lesser number of cells without departing from the intent and ambit of this disclosure.

As noted, cellular cluster A 202 can be comprised of cells A1, A2, and A3, wherein the cellular cluster A 202, can have been previously optimized as a function of cell-level data sources, such as performance counters, configuration management parameters, and/or trace data; cell information that can include cell tower geolocations and/or antenna parameters; and/or user equipment measurement reports including radio frequency and/or timing measurements obtained from each contributing cell (e.g. A1, A2, and A3). Similarly, cellular cluster B 204 can be comprised of cells B1, B2, and B3, wherein the cellular cluster B 204, can have been optimized based on one or more cell-level data sources, such as performance counters, configuration management parameters, and/or trace data; one or more cell information that can include cell tower geolocations and/or antenna parameters; and/or user equipment measurement reports including radio frequency and/or timing measurements obtained from each contributing cell (e.g., B1, B2, and B3).

On scrutiny of FIG. 2 it nevertheless will have been observed that while each of cellular cluster A 202 and cellular cluster B 204 can have been optimized (e.g., using one or more self-optimization network applications associated with operations support system 102) as a function of respective cell-level data sources, such as performance counters, configuration management parameters, and/or trace data; respective cell information that can include cell tower geolocations and/or antenna parameters; and/or user equipment measurement reports including radio frequency and/or timing measurements obtained from each contributing cell that respectively constitutes cellular cluster A 202 (e.g., cell A1, cell A2, and/or cell A3) or cellular cluster B 204 (e.g., cell B1, cell B2, and/or cell B3), a record or notation from the cell-level data sources, cell information, and/or user equipment measurement reports emanating and/or associated with cells A1 and B3, can provide indication of an inter cellular cluster (e.g., from/to cellular cluster A 202 and cellular cluster B 204) interchange, depicted as a solid line linking cell A1 and cell B3, has taken place. Such indication of inter cellular cluster transmissions (rather than an intra cellular cluster communication) between cells associated with distinct optimized or optimizable cell clusters (e.g., cellular cluster A 202 and/or cellular cluster B 204) can cause self-optimization network applications executing on operations support system 102, for instance, to deleteriously and inadvertently make changes to one or both of cell A1 and/or B3, reducing the intended coverage area of cells A1 and/or cell B3, and thus upsetting the optimized balance of cellular cluster A 202, cellular cluster B 204, and as a possible consequential effect the cellular network 200 as a whole. Under these circumstances, where an exchange between cell A1in cellular cluster A 202 and cell B3 in cellular cluster B 204 is detected, cell A1and/or cell B3 can be classified as potential overshooting cells.

As has been stated above, the disclosed systems and methods detect overshooting cells as a function of, or based on, network measurement data. Utilizing network measurement data, rather than relying on non-systematic analysis of drive test data, provides a tremendous improvement over current overshooting detection procedures. In line with detecting overshooting cells as a function of network measurement data, the described systems and methods examine for the existence of neighbor cells that can exist between a detected overshooting cell and a serving cell or serving area. The systems and methods enunciated herein can have application for both geo-based and/or non geo-based self-optimization network applications.

Generally, input that can be employed by the described systems and method can include cell-level data sources including performance counters, configuration management parameters, trace data, cell information that can include cell tower geolocation and antenna parameters, mobile device or user equipment measurement reports that can include radio frequency measurements and/or timing measurements. Particular inputs that can beneficially be utilized by the disclosed systems and methods can include network parameters, handover statistics, and/or mobile device or user equipment measurements reports.

In the context of network parameters, these can include, for a given geographical area, information regarding universal mobile telecommunications system (UMTS), code division multiple access (CDMA), and/or Long Term Evolution (LTE) standard cells extant within the geographical area.

With regard to the handover statistics, these can include statistics associated with handover events that are occurring, or have occurred, between cells within the geographical area.

In connection with the mobile device or user equipment measurement reports, these reports can indicate measurement data of wireless signals received by each mobile device or user equipment extant within the communication ambit or coverage area provided by a cell or cluster of cells. In accordance with an aspect, the mobile device or user equipment measurement reports can be associated with exact or estimated location information (e.g., geo-tag). In accordance with another aspect, the mobile device or user equipment measurement reports may not include location information associated with a mobile device or user equipment location (e.g. non-geo-tagged). In accordance with a further aspect, there can be instances where user equipment or mobile devices fail to generate and/or dispatch a measurement reports. Nevertheless, regardless as to whether or not a measurement report is received from user equipment or mobile devices extant within the coverage area associated with a cell or cluster of cells, or whether or not geographical information is also included with the measurement reports, the detection of the overshooting cells by the described systems and methods can be carried out.

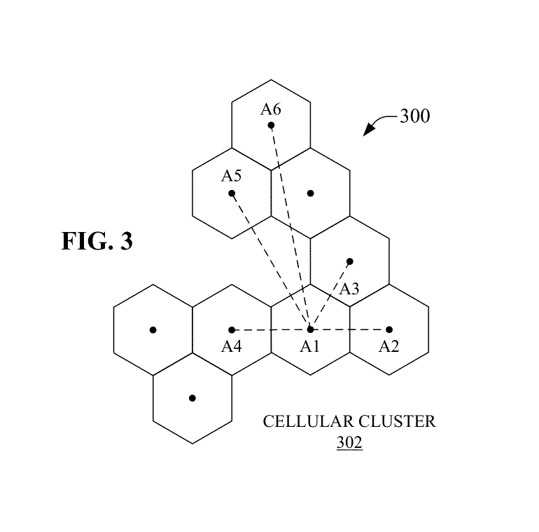

In accordance with an embodiment, the disclosed methods executing on operations support system 102, for example, can include a data preparation or screening stage wherein handover statistics regarding neighbor relations between various cells can be collected from the network (e.g., cellular network 100). The neighbor relations regarding these cells can then be ranked. For instance with reference to FIG. 3 that depicts cellular cluster 302 that includes, for instance, from the perspective of cell A1 and as a function of the handover statistics, the assessed neighbor relations between cell A1 and cells A2-A6. Thus, as represented in FIG. 3, operations support system 102, as a function of the handover statistics received from cellular network 100, for instance, can determine with respect to cell A1, that cell A1 has five identified neighbors (e.g., A2, A3, A4, A5, and A6). Further, operations support system 102, once again, for example, as a function of received handover statistics and from the perspective of cell A1, can ascertain the median site-to-site distance between cell A1 and each of its identified neighbors (e.g., A1→A2, A1→A3, A1→A4, A1→A5, and A1→A6). Thereafter, outliers based, for example, on the median site-to-site distances between cell A1 and each of its identified neighbors can be excluded. For example, in relation to the median site-to-site distance between cell A1 and its neighbors cells A5 and A6 can have been deemed as having been outliers. This collation and/or ranking of the neighbor relations, and the exclusion of outlying neighbor cells as an assessment of the median of the distances between pairs of neighboring cells can be performed for each cell in cellular cluster 302. Once operations support system 102 has detected and/or eliminated outliers based on, or as a function of, the median of the site-to-site distances between each pair of cells included in the cellular cluster (e.g., cellular cluster 302), a set of, or a list of, screened cells is obtained. It should be noted in regard to the utilization of the term “set”, “set” denotes a set with at least one member; a “set” as utilized in this disclosure therefore precludes a null or empty set.

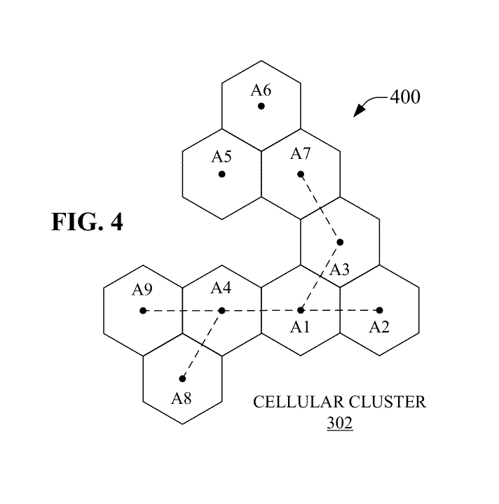

Once operations support system 102 has ascertained a set of, or a list of, screened cells, operations support system 102 can proceed to the second stage, wherein screened cells can be classified as potentially/candidate overshooting cells. Here operations support system 102, for each cell included in the set of, or list of, screened cells associated with the cellular cluster (e.g., cellular cluster 302) checks the neighbor relations of each of its neighbors' neighbors. For example, FIG. 4 provides a further illustration of cellular cluster 302, wherein from the perspective of cell A1, each of its neighbors' (e.g. cell A2, cell A3, and cell A4) are employed to determine whether or not these cells (e.g., cell A2, cell A3, and cell A4) have neighbors. As depicted in FIG. 4, it will be observed that cell A2 does not have neighbors aside from cell A1 and cell A3, though cell A3 has one proximate neighbor cell A7, and cell A4 has two neighbors in close proximity, cell A8 and cell A9. Thus, for each neighbor, where the total number of its neighbors exceeds a threshold (a configurable parameter) and the distance between the screened cell (e.g. cell A1) and the distance between its neighbors (e.g., cell A3 and cell A4) is larger than a multiple of the median site-to-site distance, as ascertained earlier at the screening stage above, such cells can be categorized as a potentially/candidate overshooting cell.

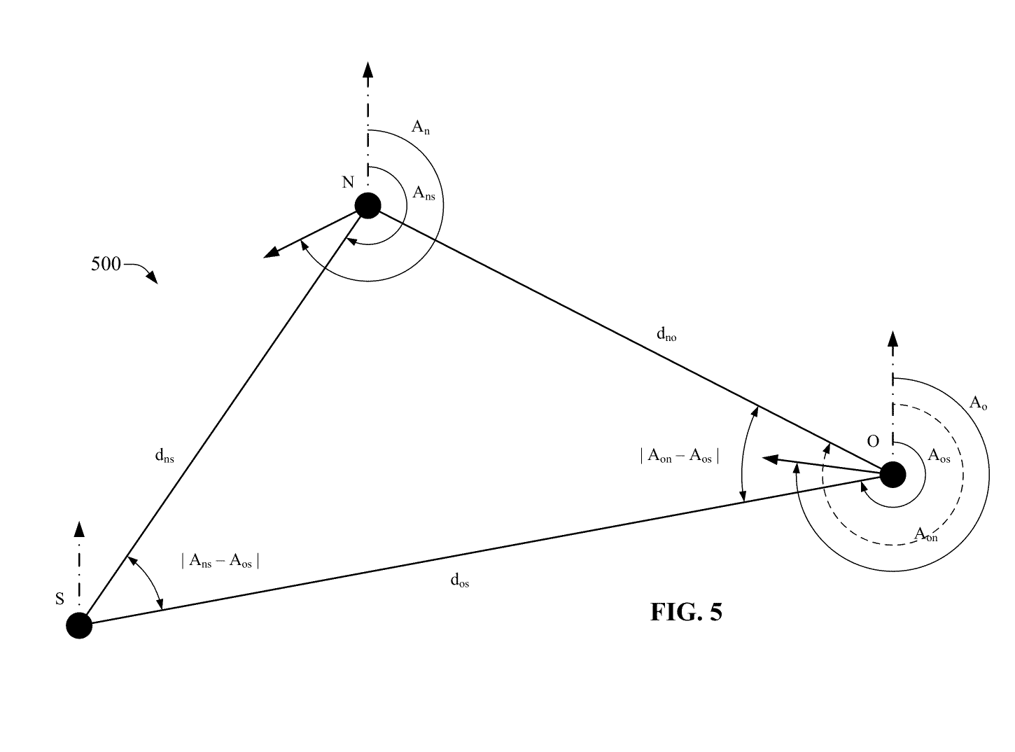

With reference to FIG. 5, once the potentially/candidate overshooting cells have been identified these cells can be subjected to a site-in-between check to determine whether or not there exists a site-in-between the screened cell (S) and the potentially/candidate overshooting cell (O). As illustrated in FIG. 5, if there exists a site-in-between (e.g., cell N) the screened cell (S) and the potentially/candidate overshooting cell (O), the potentially/candidate overshooting cell (O) can be classified as an overshooting neighbor cell. Additionally, during determination for the existence of in between sites, an estimation of the coverage footprint of the site-in-between (e.g., cell N) can be performed. Based on the estimation of the coverage footprint of the site-in-between (cell N), a cell (O) is not classified as an overshooting cell if the site-in-between (N) has a small coverage footprint.

The site-in-between check, as performed by operations support system 102, can be based on, or effectuated as a function of, azimuth direction and distances as illustrated in FIG. 5. Thus, from received network parameters relating to or in regard to cell azimuth and location, the relative distances (e.g., dₙₛ, dₙₒ, dₒₛ) between each pair of cells (e.g., S→N, N→O, S→O) and the relative azimuths Aₒₛ (from cell O to cell S), Aₙₛ, (from cell N to cell S), Aₒₙ (from cell O to cell N) can be ascertained. Operations support system 102 can then verify whether the relative distances between each pair of cells and the relative azimuths between each pair of cells, as a function of the series of distance and direction comparisons (including |Aₒₛ-Aₒ|, |Aₙₛ-Aₙ|, |Aₒₙ-Aₒₛ|, |Aₙₛ-Aₒₛ|, dₙₛ/dₒₛ, dₙₒ/dₒₛ) satisfy a predefined condition. Where the relative distances between each pair of cells, the relative azimuths between each pair of cells, and possibly together with other indicia, meets the predefined conditions, the cell in between the screened cell (S) and the potentially/candidate overshooting cell (O) can be classified as an in between cell (N), and the potentially/candidate overshooting cell (O) can be categorized as an overshooting cell (O).

The site-in-between check carried out by operations support system 102 can typically be performed by using every neighbor cell in the list of screened cells and the neighbors of every neighbor cell and flagging overshooting cells whenever there exists a neighbor cell that passes the site-in-between check. The ensuing list of identified overshooting cells can thereafter be output from operations support system 102 for use by one or more self optimization network algorithms to optimize cell clusters and ultimately the entire network.

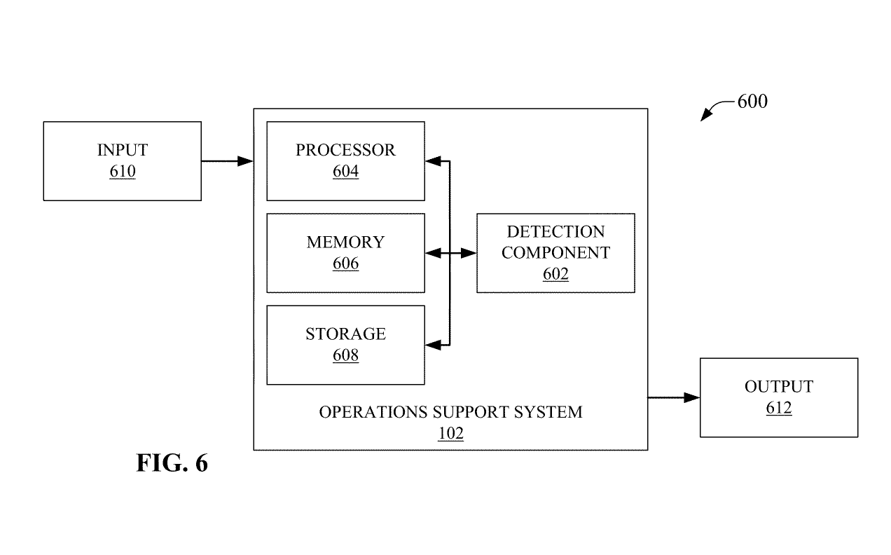

Turning now to FIG. 6 that provides a non-limiting illustration of operations support system 102 that can include detection component 602 that can be in communication with processor 604 for facilitating operation of computer executable instructions and components by operations support system 102, memory 606 for storing computer executable components and instructions, and storage 608 for providing longer term storage of data and/or computer executable components and instructions. Additionally, operations support system 102 can receive input 610 in the form cell-level data sources, such as performance counters, configuration management parameters, trace data, cell information including cell tower geolocation and antenna parameters, mobile device or user equipment measurement reports that can include radio frequency measurements and/or timing measurements. Further, operations support system 102 can output lists of identified overshooting cells that can be beneficially employed by self optimization network algorithms to optimize cell clusters.

Detection component 602, in a screening or data preparation stage, can collect handover statistics regarding neighbor relations between the various cells from the cellular network (e.g., received as input 610). Base at least in part on the handover collected handover statistics, the neighbor relations regarding the various cells can be ranked. Further, detection component 602, as a function of the collected handover statistics can determine a median site-to-site distance between the various cells and each of their neighbors. Detection component 602 can, as a function of the ascertained median site-to-site distances can exclude outliers, thereby producing a set of, or a list of, screened cells.

Detection component 602 can thereafter classify the screened cells as potentially/candidate overshooting cells. In order to classify the screened cells as potentially/candidate overshooting cells, detection component 602, for each cell included in the list or set of screened cells can check the neighbor relations of each screened cells' neighbors' neighbor. Detection component 602 for each neighbor can therefore determine whether or not the total number of neighbors exceeds a threshold, and further ascertain whether the distance between the screened cell and its neighbors exceeds a multiple of the median site-to-site distance, cells that satisfy these condition can be categorized as a potentially/candidate overshooting cell by detection component 602.

Detection component 602, as a function of the list or set of identified potentially/candidate overshooting cells, can subject each of the potentially/candidate overshooting cells to a site-in-between check to ascertain whether or not there exists a site-in-between the screened cell and the potentially/candidate overshooting cell. Where a site-in-between exists between the screened cell and the potentially/candidate overshooting cell, the potentially/candidate overshooting cell can be classified as an overshooting neighbor cell. Additionally, during determination for the existence of in between sites detection component 602 can also effectuate an estimation of the coverage footprint of the identified site-in-between. Where detection component 602 ascertains, as a function of the effectuated estimation, that the coverage footprint of the site-in-between site is small the potentially/candidate overshooting cell is not classified as an overshooting cell.

Detection component 602 can perform the site-in-between check as a function azimuth direction and distances. Thus, from received network parameters relating to cell azimuth and location (received as input 610), detection component 602 can determine the relative distances between each pair of cells and the relative azimuths between each pair of cells, and thereafter can verify whether the relative distances between each pair of cells and the relative azimuths between each pair of cells, as a function of the series of distance and direction comparisons, satisfy predefined conditions. Where the relative distances between each pair of cells, the relative azimuths between each pair of cells, and possibly together with other indicia, meet the predefined conditions, the cell in between the screened cell and the potentially/candidate overshooting cell can be classified as an in between cell and the potentially/candidate overshooting cell can be categorized as an overshooting cell.

As noted above, the performed site-in-between check can utilize every neighbor cell in the list of screened cells and can flag overshooting cells whenever there exists a neighbor cell that passes the site-in-between check. The resulting list of identified overshooting cells can thereafter be output (e.g., output 612) and used by one or more self optimization network algorithms or applications to optimize cell clusters and ultimately the network in its entirety.

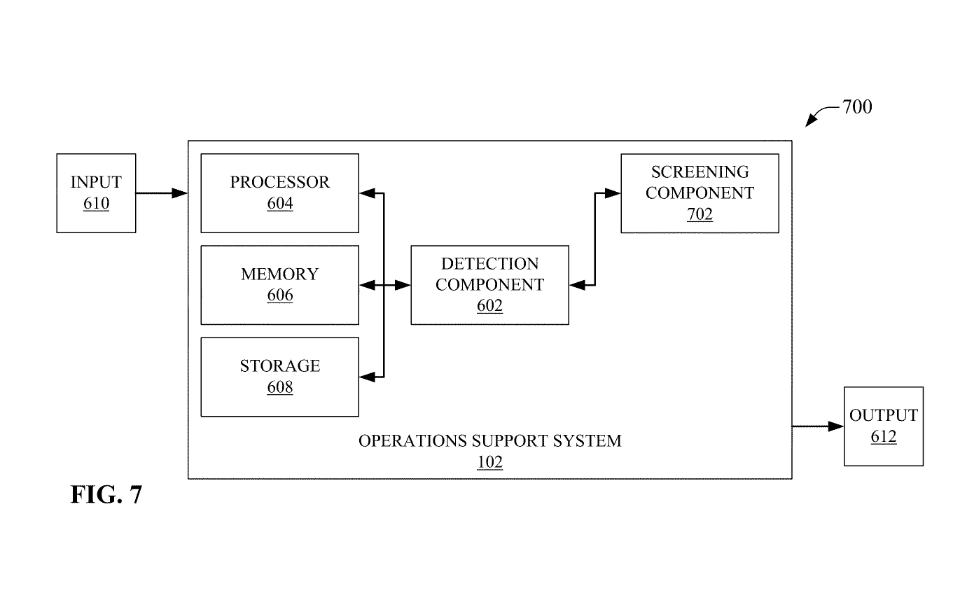

FIG. 7 provides a further non-limiting illustration of operations support system 102, wherein operations support system 102 can include screening component 702 in addition to previously outlined detection component 602, processor 604, memory 606, and storage 608. Further, as noted in regard to FIG. 6 operations support system 102 can receive input 610 and generate and dispatch output 612. Screening component 702 can operate in conjunction or collaboration with detection component 602. In this regard, screening component 702, in response to receiving handover statistics from the network (e.g., cellular network 100) can collate and/or rank the neighbor relations between the various cells a function of the handover statistics. Thereafter, screening component 702 can discard outliers as a function of determined median site-to-site distances between a cell and each of its identified neighbors. The collection and/or ordering of the neighbor relations, and the exclusion of outlier neighbor cells as an assessment of the median of the distances between pairs of neighboring cells can be performed by screening component 702 for each cell in a cell cluster and/or the network in general. Screening component 702 can thereupon generate or create a set of, or a list of, screened cells. It should be observed once again that the term “set” is utilized in this disclosure as denoting a set with at least one member and therefore precludes a null or empty set.

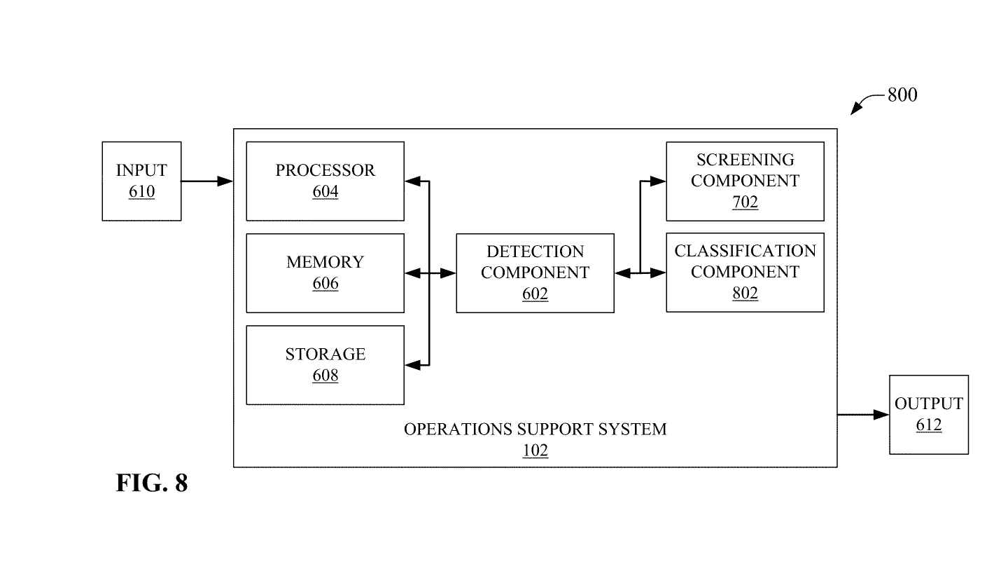

FIG. 8 provides a further non-limiting depiction of operations support system 102 in accordance with the subject disclosure. As illustrated, operations support system 102 can include classification component 802, in addition to screening component 702, detection component 602, processor 604, memory 606, and storage 608, discussed above in connection with FIGS. 6-7. Classification component 802, in response to receiving a set of, or a list of, screened cells from screening component 702, can categorize the screened cells as potentially/candidate overshooting cells, wherein for each cell included in the list or set of screened cells classification component 802 checks the neighbor relations of each of the screened cell's neighbors' neighbors. FIG. 4 provides illustration of checking the neighbor relations of each screened cell's neighbor. Thus, classification component 802, for each neighbor can determine the total number of neighbor relationships and based at least in part on the ascertained total number of relationship being in excess of a configurable threshold and the distances between the screened cell and its neighbors exceeding a multiple of the median site-to-site distance, as ascertained earlier by screening component 702, can identify potentially/candidate overshooting cells.

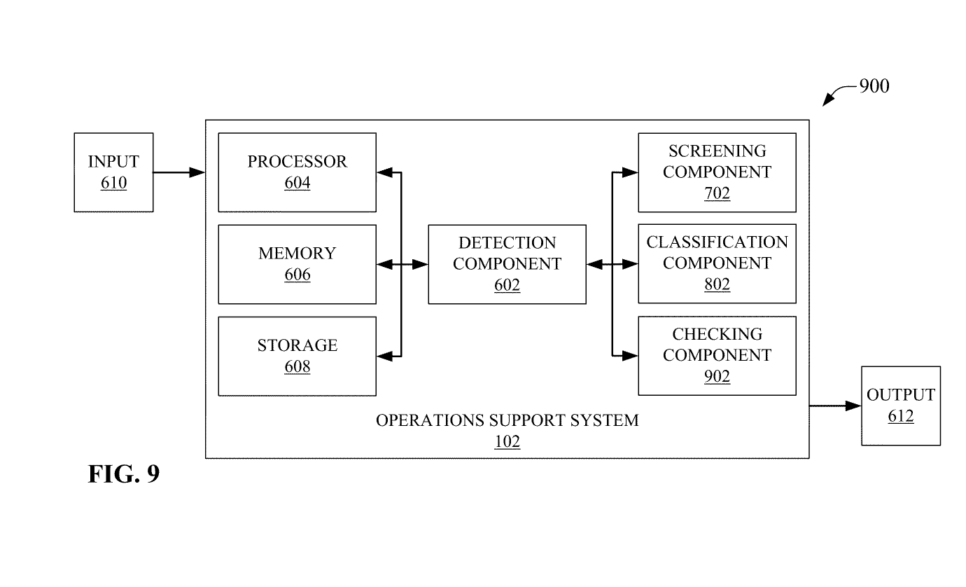

FIG. 9 provides another non-limiting depiction of operations support system 102. As illustrated, operations support system 102 can include checking component 902 that can operate in collaboration with detection component 602, screening component 702, classification component 802. Further checking component 902 can execute on, or be executed by, processor 604, and can utilize the functionalities provided by memory 606 and storage 608. Checking component 902, as a function of the potentially/candidate overshooting cells identified by classification component 802, can perform a site-in-between check to ascertain for the existence of a site situated in between the screened cell and the potentially/candidate overshooting cell. Where an in-between-site is identified between the screened cell and the potentially/candidate overshooting cell, checking component 902 can categorize the potentially/candidate overshooting cell as being an overshooting neighbor cell. During determination for the existence of in-between-sites, checking component 902 can estimate the coverage footprint of the site-in-between site. Based on the estimation of the coverage footprint of the site in between, a cell determined to have a small coverage footprint is not classified as an overshooting cell where the in between site has a small coverage footprint.

The site-in-between check, as performed by checking component 902, can be based on, or effectuated as a function of, azimuth direction and distance. Accordingly with reference to FIG. 5, checking component 902 as a function of cell azimuth and location, the relative distances (e.g., dₙₛ, dₙₒ, dₒₛ) between each pair of cells (e.g., cell (S) to cell (N), cell (N) to cell (O), and cell (S) to cell (O)) and the relative azimuths Aₒₛ (from cell O to cell S), Aₙₛ, (from cell N to cell S), Aₒₙ (from cell O to cell N) can be ascertained. Checking component 902 can then verify whether the relative distances between each pair of cells and the relative azimuths between each pair of cells, as a function of a series of distance and direction comparisons (including |Aₒₛ-Aₒ|, |Aₙₛ-Aₙ|, |Aₒₙ-Aₒₛ|, |Aₙₛ-Aₒₛ|, dₙₛ/dₒₛ, dₙₒ/dₒₛ) satisfy a predefined condition. Where the relative distances between each pair of cells, the relative azimuths between each pair of cells, and possibly together with other indicia, meets the predefined condition, the cell (e.g., cell (N)) in between the screened cell (S) and the potentially/candidate overshooting cell (O) can be classified as an in between cell (N), and the potentially/candidate overshooting cell (O) can be categorized as an overshooting cell (O).

The site-in-between check performed by checking component 902 can be performed by using every neighbor cell in the list of screened cells and flagging overshooting cells whenever there exists a neighbor cell that passes the site-in-between check. The ensuing list of identified overshooting cells can thereafter be output from operations support system 102 for use by one or more self optimization network algorithms to optimize cell clusters and ultimately the entire network.

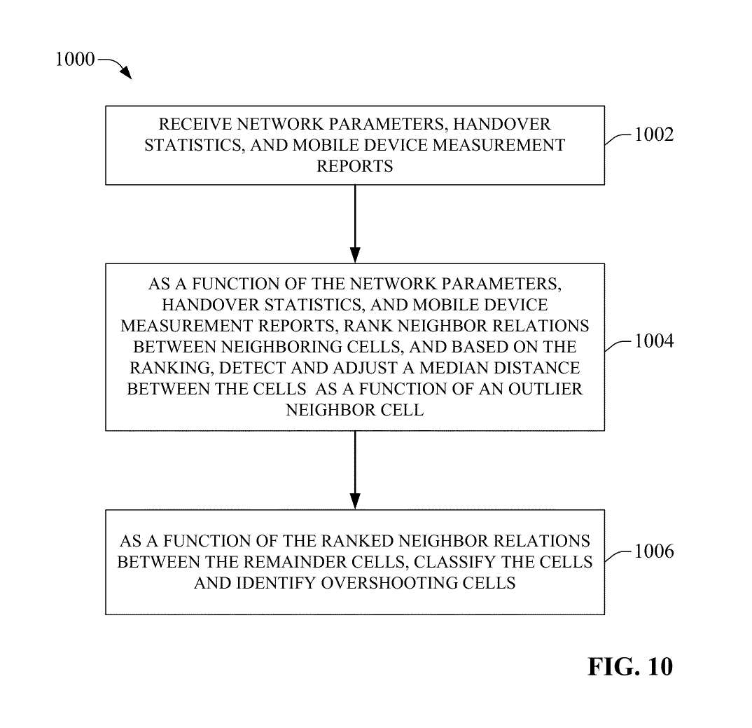

In view of the example system(s) described above, example method(s) that can be implemented in accordance with the disclosed subject matter can be better appreciated with reference to flowcharts in FIG. 10-FIG. 13. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 10 illustrates a method 1000 for facilitating overshooting cell detection for self optimizing network applications. The method can commence at 1002 where network parameters, handover statistics, and mobile device measurement reports can be received (e.g., received by operations support system 102). At 1004 operations support system 102, as a function of the received network parameters, handover statistics, and mobile device measurement reports, can rank neighbor relations between neighboring cells, and based on the ranking, detect and adjust a median distance between the cells as a function of outlier neighbor cells. Thereafter, at 1006, operations support system 102, as a function of the ranked neighbor relations between the remaining cells (e.g., after exclusion of outlier neighbor cells), can classify the cells and identify overshooting cells.

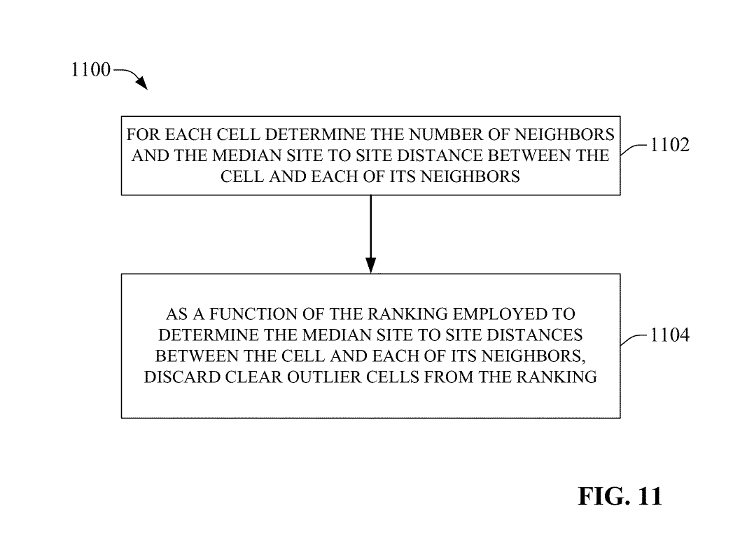

FIG. 11 illustrates a further method 1100 for facilitating overshooting cell detection for self optimizing network applications. The method can commence at 1102 wherein operations support system 102 (and/or detection component 602 and/or screening component 702), for each cell can determine the number of neighbors and the median site-to-site distance between the cell at issue and each of its neighbors. At 1104 operations support system 102 (and detection component 602 and/or screening component 702), as a function of a ranking employed to ascertain the median site-to-site distance between a cell at issue and each of the cell at issue's neighbors, can exclude or discard cells from the ranking that are outliers based on the median site-to-site distance.

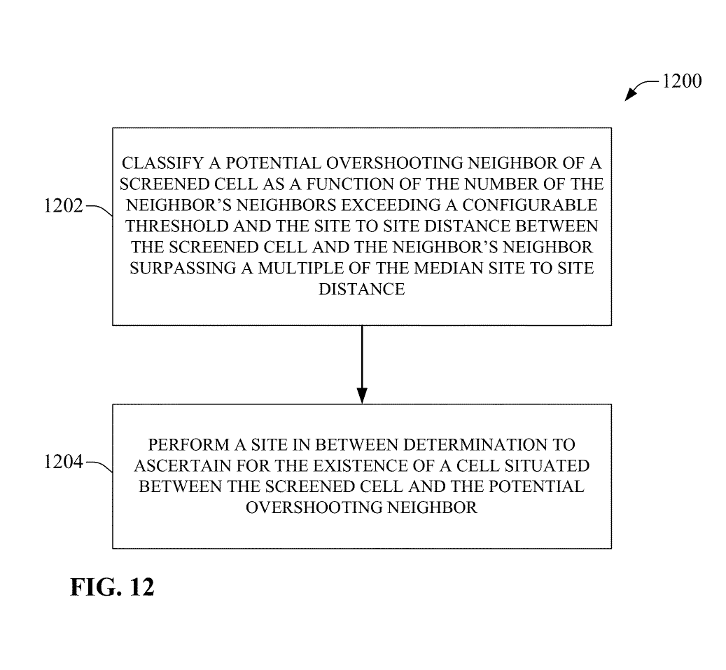

FIG. 12 illustrates a further method 1200 for facilitating overshooting cell detection for self optimizing network applications. The method can commence at 1202 where operations support system 102 (and/or detection component 602, screening component 702, and classification component 802) can classify potential overshooting neighbors of a screened cell as a function of the number of the neighbor's neighbors exceeding a configurable threshold and the site-to-site distance between the screened cell and the neighbor surpassing a multiple of a median site-to-site distance. At 1204 operations support system 102 can perform a site-in-between determination to ascertain for the existence of a cell situated between a screened cell and a potential overshooting neighbor cell.

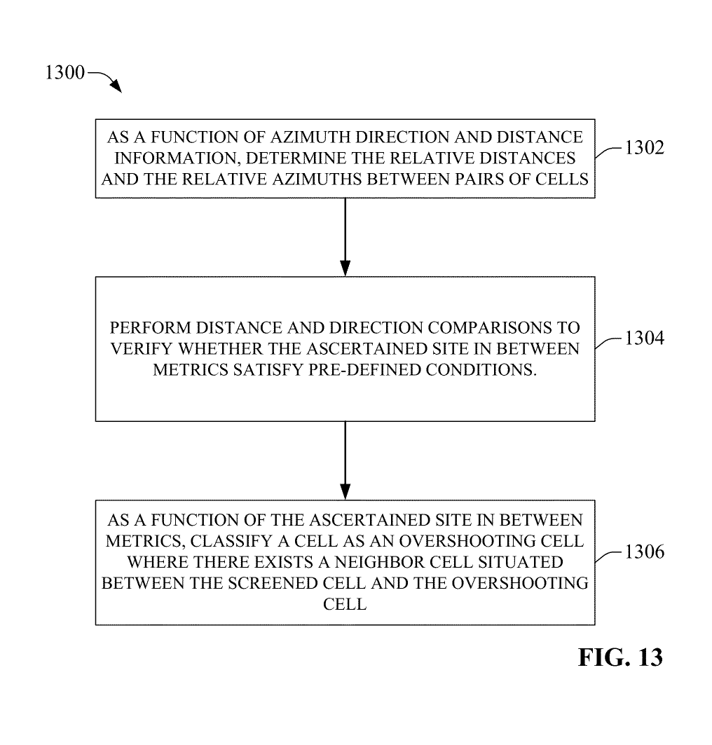

FIG. 13 illustrates another method 1300 for facilitating overshooting cell detection for self optimizing network applications. The method can commence at 1302 where operations support system 102 (and/or detection component 602, screening component 702, classification component 802, and checking component 902), as a function of azimuth direction and distance information can determine the relative distances and relative azimuths between pairs of cells. At 1304 operations support system 102 can perform distance and direction comparisons to verify whether or not the ascertained site-in-between metrics satisfy pre-defined conditions. At 1306 operations support system 102 as a function of the ascertained site-in-between metrics can classify a cell as being an overshooting cell where there exists a neighbor cell located between the screened cell and the overshooting cell.

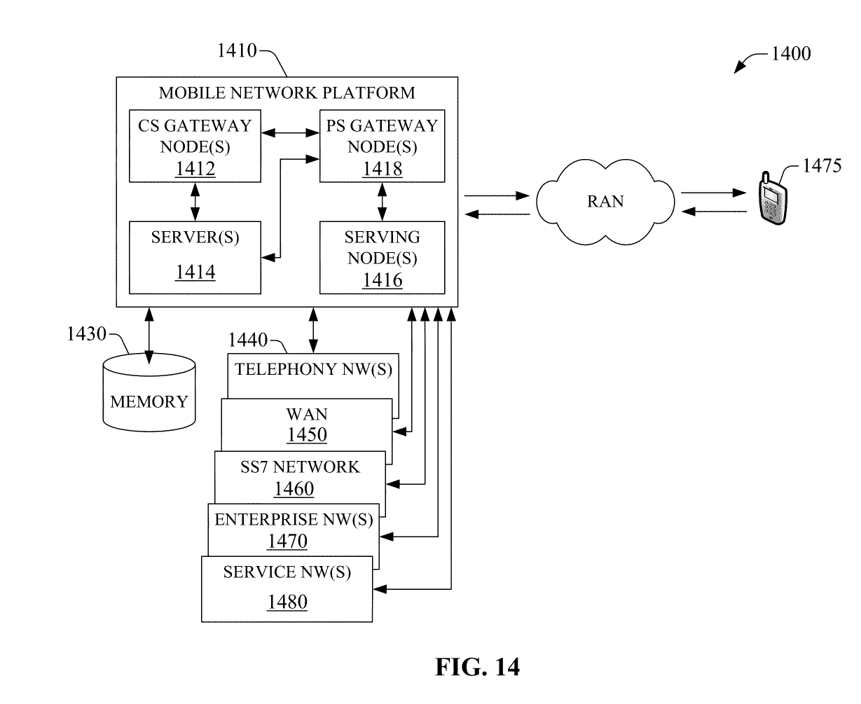

FIG. 14 presents an example embodiment 1400 of a mobile network platform 1410 that can implement and exploit one or more aspects of the disclosed subject matter described herein. Generally, wireless network platform 1410 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 1410 can be included in telecommunications carrier networks, and can be considered carrier-side components as discussed elsewhere herein. Mobile network platform 1410 includes CS gateway node(s) 1412 which can interface CS traffic received from legacy networks like telephony network(s) 1440 (e.g., public switched telephone network (PSTN), or public land mobile network (PLMN)) or a signaling system #7 (SS7) network 1470. Circuit switched gateway node(s) 1412 can authorize and authenticate traffic (e.g., voice) arising from such networks. Additionally, CS gateway node(s) 1412 can access mobility, or roaming, data generated through SS7 network 1470; for instance, mobility data stored in a visited location register (VLR), which can reside in memory 1430. Moreover, CS gateway node(s) 1412 interfaces CS-based traffic and signaling and PS gateway node(s) 1418. As an example, in a 3GPP UMTS network, CS gateway node(s) 1412 can be realized at least in part in gateway GPRS support node(s) (GGSN). It should be appreciated that functionality and specific operation of CS gateway node(s) 1412, PS gateway node(s) 1418, and serving node(s) 1416, is provided and dictated by radio technology(ies) utilized by mobile network platform 1410 for telecommunication.

In addition to receiving and processing CS-switched traffic and signaling, PS gateway node(s) 1418 can authorize and authenticate PS-based data sessions with served mobile devices. Data sessions can include traffic, or content(s), exchanged with networks external to the wireless network platform 1410, like wide area network(s) (WANs) 1450, enterprise network(s) 1470, and service network(s) 1480, which can be embodied in local area network(s) (LANs), can also be interfaced with mobile network platform 1410 through PS gateway node(s) 1418. It is to be noted that WANs 1450 and enterprise network(s) 1460 can embody, at least in part, a service network(s) like IP multimedia subsystem (IMS). Based on radio technology layer(s) available in technology resource(s) 1417, packet-switched gateway node(s) 1418 can generate packet data protocol contexts when a data session is established; other data structures that facilitate routing of packetized data also can be generated. To that end, in an aspect, PS gateway node(s) 1418 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 1400, wireless network platform 1410 also includes serving node(s) 1416 that, based upon available radio technology layer(s) within technology resource(s) 1417, convey the various packetized flows of data streams received through PS gateway node(s) 1418. It is to be noted that for technology resource(s) 1417 that rely primarily on CS communication, server node(s) can deliver traffic without reliance on PS gateway node(s) 1418; for example, server node(s) can embody at least in part a mobile switching center. As an example, in a 3GPP UMTS network, serving node(s) 1416 can be embodied in serving GPRS support node(s) (SGSN).

For radio technologies that exploit packetized communication, server(s) 1414 in wireless network platform 1410 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 1410. Data streams (e.g., content(s) that are part of a voice call or data session) can be conveyed to PS gateway node(s) 1418 for authorization/authentication and initiation of a data session, and to serving node(s) 1416 for communication thereafter. In addition to application server, server(s) 1414 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 1410 to ensure network's operation and data integrity in addition to authorization and authentication procedures that CS gateway node(s) 1412 and PS gateway node(s) 1418 can enact. Moreover, provisioning server(s) can provision services from external network(s) like networks operated by a disparate service provider; for instance, WAN 1450 or Global Positioning System (GPS) network(s) (not shown). Provisioning server(s) can also provision coverage through networks associated to wireless network platform 1410 (e.g., deployed and operated by the same service provider), such as femto-cell network(s) (not shown) that enhance wireless service coverage within indoor confined spaces and offload radio access network resources in order to enhance subscriber service experience within a home or business environment by way of UE 1475.

It is to be noted that server(s) 1414 can include one or more processors configured to confer at least in part the functionality of macro network platform 1410. To that end, the one or more processor can execute code instructions stored in memory 1430, for example. It is should be appreciated that server(s) 1414 can include a content manager 1415, which operates in substantially the same manner as described hereinbefore.

In example embodiment 1400, memory 1430 can store information related to operation of wireless network platform 1410. Other operational information can include provisioning information of mobile devices served through wireless platform network 1410, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 1430 can also store information from at least one of telephony network(s) 1440, WAN 1450, enterprise network(s) 1460, or SS7 network 1470. In an aspect, memory 1430 can be, for example, accessed as part of a data store component or as a remotely connected memory store.

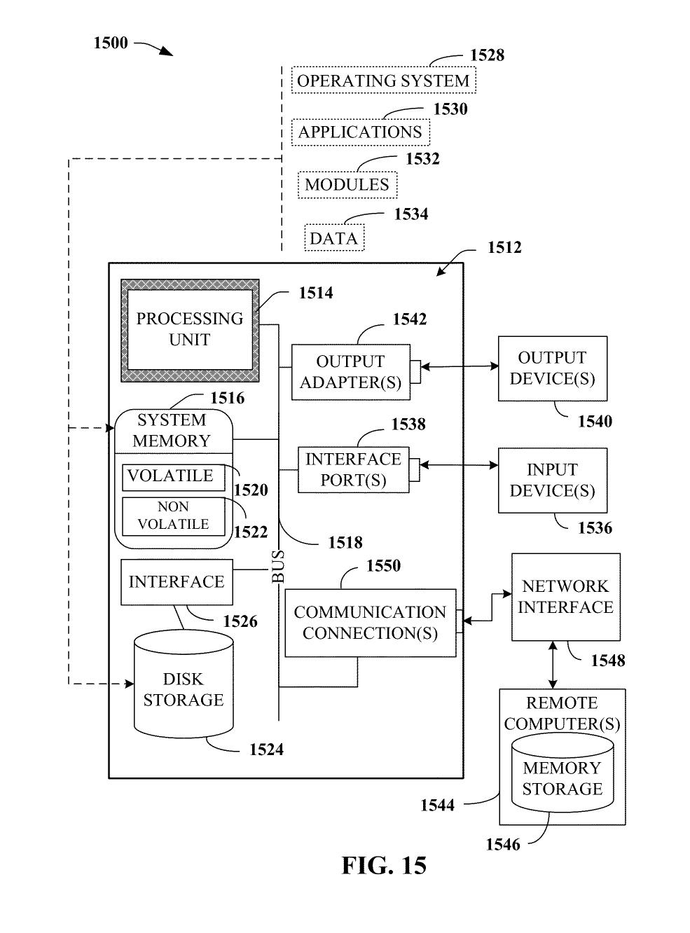

In order to provide a context for the various aspects of the disclosed subject matter, FIG. 15, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory, by way of illustration, and not limitation, volatile memory 1520 (see below), non-volatile memory 1522 (see below), disk storage 1524 (see below), and memory storage 1546 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 15 illustrates a block diagram of a computing system 1500 operable to execute the disclosed systems and methods in accordance with an embodiment. Computer 1512, which can be, for example, part of the hardware of an operating support system 102 or user equipment, includes a processing unit 1514, a system memory 1516, and a system bus 1518. System bus 1518 couples system components including, but not limited to, system memory 1516 to processing unit 1514. Processing unit 1514 can be any of various available processors. Dual microprocessors and other multiprocessor architectures also can be employed as processing unit 1514.

System bus 1518 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics, VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 1516 can include volatile memory 1520 and nonvolatile memory 1522. A basic input/output system (BIOS), containing routines to transfer information between elements within computer 1512, such as during start-up, can be stored in nonvolatile memory 1522. By way of illustration, and not limitation, nonvolatile memory 1522 can include ROM, PROM, EPROM, EEPROM, or flash memory. Volatile memory 1520 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1512 can also include removable/non-removable, volatile/non-volatile computer storage media. FIG. 15 illustrates, for example, disk storage 1524. Disk storage 1524 includes, but is not limited to, devices like a magnetic disk drive, floppy disk drive, tape drive, flash memory card, or memory stick. In addition, disk storage 1524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1524 to system bus 1518, a removable or non-removable interface is typically used, such as interface 1526.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 15 describes software that acts as an intermediary between users and computer resources described in suitable operating environment 1500. Such software includes an operating system 1528. Operating system 1528, which can be stored on disk storage 1524, acts to control and allocate resources of computer system 1512. System applications 1530 take advantage of the management of resources by operating system 1528 through program modules 1532 and program data 1534 stored either in system memory 1516 or on disk storage 1524. It is to be noted that the disclosed subject matter can be implemented with various operating systems or combinations of operating systems.

A user can enter commands or information into computer 1512 through input device(s) 1536. As an example, operations support system 102 can include a user interface embodied in a touch sensitive display panel allowing a user to interact with computer 1512. Input devices 1536 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1514 through system bus 1518 by way of interface port(s) 1538. Interface port(s) 1538 include, for example, a serial port, a parallel port, a game port, a universal serial bus (USB), an infrared port, a Bluetooth port, an IP port, or a logical port associated with a wireless service, etc. Output device(s) 1540 use some of the same type of ports as input device(s) 1536.

Thus, for example, a USB port can be used to provide input to computer 1512 and to output information from computer 1512 to an output device 1540. Output adapter 1542 is provided to illustrate that there are some output devices 1540 like monitors, speakers, and printers, among other output devices 1540, which use special adapters. Output adapters 1542 include, by way of illustration and not limitation, video and sound cards that provide means of connection between output device 1540 and system bus 1518. It should be noted that other devices and/or systems of devices provide both input and output capabilities such as remote computer(s) 1544.

Computer 1512 can operate in a networked environment using logical connections to one or more remote computers, such as remote computer(s) 1544. Remote computer(s) 1544 can be a personal computer, a server, a router, a network PC, cloud storage, cloud service, a workstation, a microprocessor based appliance, a peer device, or other common network node and the like, and typically includes many or all of the elements described relative to computer 1512.

For purposes of brevity, only a memory storage device 1546 is illustrated with remote computer(s) 1544. Remote computer(s) 1544 is logically connected to computer 1512 through a network interface 1548 and then physically connected by way of communication connection 1550. Network interface 1548 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit-switching networks like Integrated Services Digital Networks (ISDN) and variations thereon, packet switching networks, and Digital Subscriber Lines (DSL). As noted below, wireless technologies may be used in addition to or in place of the foregoing.

Communication connection(s) 1550 refer(s) to hardware/software employed to connect network interface 1548 to bus 1518. While communication connection 1550 is shown for illustrative clarity inside computer 1512, it can also be external to computer 1512. The hardware/software for connection to network interface 1548 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a memory to store instructions; and
a processor, communicatively coupled to the memory, that facilitates execution of the instructions to perform operations, comprising:
ranking a first neighbor relationship between a first cell device and a second cell device and a second neighbor relationship between the first cell device and a third cell device, wherein the first neighbor relationship and the second neighbor relationship are determined as a function of a statistical record of a transfer of a wireless service from the first cell device to the second cell device and the statistical record of the transfer of the wireless service from the first cell device to the third cell device, wherein the statistical record of the transfer of the wireless service is received from a network device of a cellular network;
identifying one of the second cell device or the third cell device as an outlier neighbor cell device based on a first ranking of the first neighbor relationship and a second ranking of the second neighbor relationship; and
identifying, as a function of an azimuth direction and a distance between respective cell devices of a group of screened cell devices, an overshooting cell device that propagates a transmitted radio frequency signal causing interference to a cell device included in the group of screened cell devices.

2. The system of claim 1, wherein the ranking of the first neighbor relationship and the second neighbor relationship comprises determining a median distance of distances including a first distance between the first cell device and the second cell device and a second distance between the first cell device and the third cell device.

3. The system of claim 2, wherein the operations further comprise omitting the outlier neighbor cell device from the group of screened cell devices as a function of a first comparison of the median distance with the first distance, and a second comparison of the median distance with the second distance.

4. The system of claim 3, wherein the identifying the overshooting cell device comprises classifying a candidate for the overshooting cell device associated with the group of screened cell devices based on a distance between the candidate and the first cell device exceeding a multiple of an adjusted median distance, wherein the adjusted median distance is determined after the outlier cell device is omitted.

5. The system of claim 4, wherein the classifying comprises categorizing the candidate as a function of a number of neighbor relationships established by the candidate with other cell devices exceeding a configurable threshold.

6. The system of claim 5, wherein the operations further comprise, in response to determining that an intermediary cell device is geographically situated between the first cell device and the candidate, reclassifying the candidate as the overshooting cell device.

7. The system of claim 5, wherein the operations further comprise, in response to determining that a footprint coverage area associated with the intermediary cell device satisfies a size condition, maintaining a classification for the intermediary cell device.

8. A method, comprising:
determining, by a system comprising a processor, a first relationship between the first cell device and a second cell device and a second relationship between the first cell device and a third cell device, wherein the first relationship between the first cell device and the second cell device and the second relationship between the first cell device and the third cell device is determined from a handover statistic obtained from a network device of a cellular network, and wherein the handover statistic is a statistical record of a transfer of wireless service from the first cell device to the second cell device, and from the first cell device to the third cell device;
as a function of the first relationship and the second relationship, identifying, by the system, one of the second cell device or the third cell device as an outlier cell device;
grouping, by the system, the first cell device, the second cell device, and the third cell device in data representing a plurality of screened cell devices; and
selecting, by the first cell device, an overshooting cell device, as a function of respective azimuth directions and respective distance measurements between respective cell devices included in the plurality of screened cell devices, wherein the overshooting cell device over propagates a broadcast radio frequency signal causing interference to a cell device included in the plurality of screened cell devices.

9. The method of claim 8, wherein the respective azimuth directions and the respective distance measurements between the respective cell devices are ascertained from a network parameter received, by the system, from the cellular network.

10. The method of claim 8, wherein the determining further comprises determining, by the system, a median distance of distances including a first distance between the first cell device and the second cell device, and a second distance between the first cell device and the third cell device.

11. The method of claim 10, wherein the determining comprises comparing, by the system, the median distance with the first distance and the median distance with the second distance, and determining to omit the outlier cell device from the data representing the plurality of screened cell devices based on the comparing.

12. The method of claim 10, wherein the selecting comprises identifying, by the system, a potentially overshooting cell device as a function of a distance between the potentially overshooting cell device and the first cell device exceeding a multiple of an adjusted median distance, wherein the potentially overshooting cell device is included in the data representing the plurality of screened cell devices, and the adjusted median distance is determined after the outlier cell device is omitted.

13. The method of claim 10, wherein the selecting comprises identifying, by the system, a potentially overshooting cell device based on a number of relationships established between the potentially overshooting cell device and a group of cell devices exceeding a configurable threshold, wherein the potentially overshooting cell device and the group of cell devices are included in the data representing the plurality of screened cell devices.

14. The method of claim 13, wherein the selecting further comprises classifying the potentially overshooting cell device as the overshooting cell device based on a geographically intermediate cell device being determined to be present, wherein a broadcast coverage footprint associated with the geographically intermediate cell device exceeds a broadcast coverage threshold.

15. A tangible computer readable medium comprising instructions that, in response to execution, cause a computing system including a processor to perform operations, comprising:
identifying an outlier cell device as a function of a median distance of distances including a distance between a first cell device and a second cell device and adjusting the median distance by omitting the outlier cell device from a group of screened cell devices, wherein the median distance is established from a point of view of the first cell device and determined from an analysis of transfer data representing transfer of a wireless service from the first cell device to the second cell device, and from the first cell device to the outlier cell device, wherein the transfer data is received from a network device of a cellular network; and
detecting an overshooting cell device as a function of a comparison of an azimuth direction and a distance measurement between each cell device included in the group of screened cell devices, wherein the overshooting cell causes interference to a cell included in the group of screened cell devices as a result of an over propagation of a transmitted signal.

16. The tangible computer readable medium of claim 15, wherein the azimuth direction and the distance measurement are determined from an analysis of a network parameter requested from the network device.

17. The tangible computer readable medium of claim 15, wherein the detecting comprises identifying a candidate overshooting cell device based on a distance between the candidate overshooting cell device and the first cell device and based on the candidate overshooting cell device being determined to be in excess of a multiple of an adjusted median distance, wherein the candidate overshooting cell device is included in the group of screened cell devices.

18. The tangible computer readable medium of claim 15, wherein the detecting comprises identifying a candidate overshooting cell device based on a number of relationships established between a group of cell devices exceeding a configurable reference point and based on a cell device being located between the first cell device and the candidate overshooting cell device.

19. The tangible computer readable medium of claim 15, wherein the detecting comprises:
estimating a broadcast coverage area associated with a cell device situated between the first cell device and a candidate overshooting cell device; and
classifying the candidate overshooting cell device as the overshooting cell device in response to the broadcast coverage area being determined to exceed a coverage area threshold.

20. The tangible computer readable medium of claim 19, wherein the classifying comprises eliminating the candidate overshooting cell device as a candidate for the detecting the overshooting cell device in response to the broadcast coverage area being determined not to be exceeding the coverage area threshold.
